(19) United States
(12) Patent Application Publication
(10) Pub. No.: US 2016/0291961 A1
(43) Pub. Date: Oct. 6, 2016

(54) UPDATE CONTROL METHOD AND UPDATE CONTROL DEVICE

(71) Applicant: FUJITSU LIMITED, Kawasaki-shi (JP)

(72) Inventor: Fumihiko SUWABE, Machida (JP)

(73) Assignee: FUJITSU LIMITED, Kawasaki-shi (JP)

(21) Appl. No.: 15/050,884

(22) Filed: Feb. 23, 2016

(30) Foreign Application Priority Data
Apr. 3, 2015 (JP) 2015-076834

(51) Int. Cl. G06F 9/445

(52) U.S. Cl. CPC G06F 8/65

(57) ABSTRACT

An update control device includes a storage device and a processor. The processor is configured to store task identifiers of respective tasks in the storage device in association with information on an application program or file to be used in the respective tasks. The processor is configured to update first information on a first application program or file on basis of second information on the first application program or file when a first patch program is applied. The first patch program causes a change on the first application program or file when the first patch program is applied. The first information is stored in the storage device in association with a first task identifier of a first task. The second information is included in the first patch program.

### CROSS-REFERENCE TO RELATED APPLICATION

This application is based upon and claims the benefit of priority from the prior Japanese Patent Application No. 2015-076834, filed on Apr. 3, 2015, the entire contents of which are incorporated herein by reference.

### FIELD

The embodiments discussed herein are related to an update control method and an update control device.

### BACKGROUND

An application program installed in a computer may be modified for a variety of reasons such as addition of a new feature and improvement of stability and security. The modification to the application program is performed, for example, by using a patch program for performing processing to add a new file or replace a file to be modified. Hereinafter, for simplicity of description, the word “program” may also refer to a process performed by executing a corresponding program.

An application program locks files being used such that the files being used are not modified by other programs during the use of the files. Therefore, when a patch program is applied, an application program that is using a file to be modified is stopped. Since the stopping of the application program causes, for example, interruption of a task, the number of application programs to be stopped due to the application of the patch program is desirably small.

A task performed by a user is performed using one or more application programs. In the case of a task using a plurality of application programs, even when an application program to be stopped due to the application of a patch program is only a part of the application programs used for the task, an entire task may be affected.

In relation to the stopping of a task due to the application of a patch program, there has been proposed a method of shortening the stop time of the task by managing the usage status of a virtual disk, the next start-up time, the patch application status, and the like and applying the patch program to a virtual disk in an unused state.

Further, in relation to a technique for suppressing the occurrence of problems due to the application of a patch program, there has been proposed a method of determining whether the patch program is applicable on the basis of information on the resources of a server on which the patch program is to be applied and information on the resources to be accessed by the patch program.

Related techniques are disclosed in, for example, Japanese Laid-Open Patent Publication No. 2009-289095 and Japanese Laid-open Patent Publication No. 2014-013457.

A plurality of application programs used in a task may cooperate with each other to perform the processing for the task. Therefore, when a patch program is applied to an application program, there is a risk that a task may be abnormally stopped unless the application program is stopped appropriately taking into account the cooperation of the application programs for performing the task.

A patch program may not only modify individual files, but, for example, also perform processing for modifying the correspondence between a file and an application program, or processing for adding a new file and adding the correspondence between the file and an application program. If application programs used in any tasks are stopped when the patch program is applied, the above-mentioned risk such as an abnormal stop is less likely to occur, but the scope of the tasks affected by the application of the patch program is widened.

If the correspondence relationship between an application program and a task, which is changed dynamically due to the application of a patch program, is managed appropriately, application programs to be stopped may be identified for the respective tasks when a patch program is applied. As a result, the influence of the application of a patch program on a task may be reduced.

### SUMMARY

According to an aspect of the present invention, provided is an update control device including a storage device and a processor. The processor is configured to store task identifiers of respective tasks in the storage device in association with information on an application program or file to be used in the respective tasks. The processor is configured to update first information on a first application program or file on basis of second information on the first application program or file when a first patch program is applied. The first patch program causes a change on the first application program or file when the first patch program is applied. The first information is stored in the storage device in association with a first task identifier of a first task. The second information is included in the first patch program.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a computer according to a first embodiment;

FIG. 2 is a diagram illustrating exemplary hardware configuration of an information processing apparatus according to a second embodiment;

FIG. 3 is a diagram illustrating exemplary functions of an information processing apparatus according to a second embodiment;

FIG. 4 is a diagram illustrating an example of process management information according to a second embodiment;

FIG. 5 is a diagram illustrating an example of file management information according to a second embodiment;

FIG. 6 is a diagram illustrating an example of task management information according to a second embodiment;

FIG. 7 is a diagram illustrating an example of patch data according to a second embodiment;

FIG. 8 is a diagram illustrating a method of updating task management information to be performed, when a patch program is applied, according to a second embodiment;

FIG. 9 is a diagram illustrating a method of updating task management information to be performed, when a patch program is applied, according to a second embodiment;

FIG. 10 is a diagram illustrating a method of updating task management information to be performed, when a patch program is applied, according to a second embodiment;

FIG. 11 is a flowchart illustrating a flow of processing performed by an information processing apparatus according to a second embodiment;

FIG. 12 is a flowchart illustrating a flow of processing performed by an information processing apparatus according to a second embodiment;

FIG. 13 is a flowchart illustrating a flow of processing for updating task management information performed by an information processing apparatus according to a second embodiment;

FIG. 14 is a flowchart illustrating a flow of processing for updating task management information performed by an information processing apparatus according to a second embodiment; and

FIG. 15 is a flowchart illustrating a flow of processing for updating task management information performed by an information processing apparatus according to a second embodiment.

### DESCRIPTION OF EMBODIMENTS

Hereinafter, embodiments will be described with reference to the accompanying drawings. Throughout the specification and drawings, like reference numerals will be given to elements having like functions, and a redundant description thereof will be omitted.

### First Embodiment

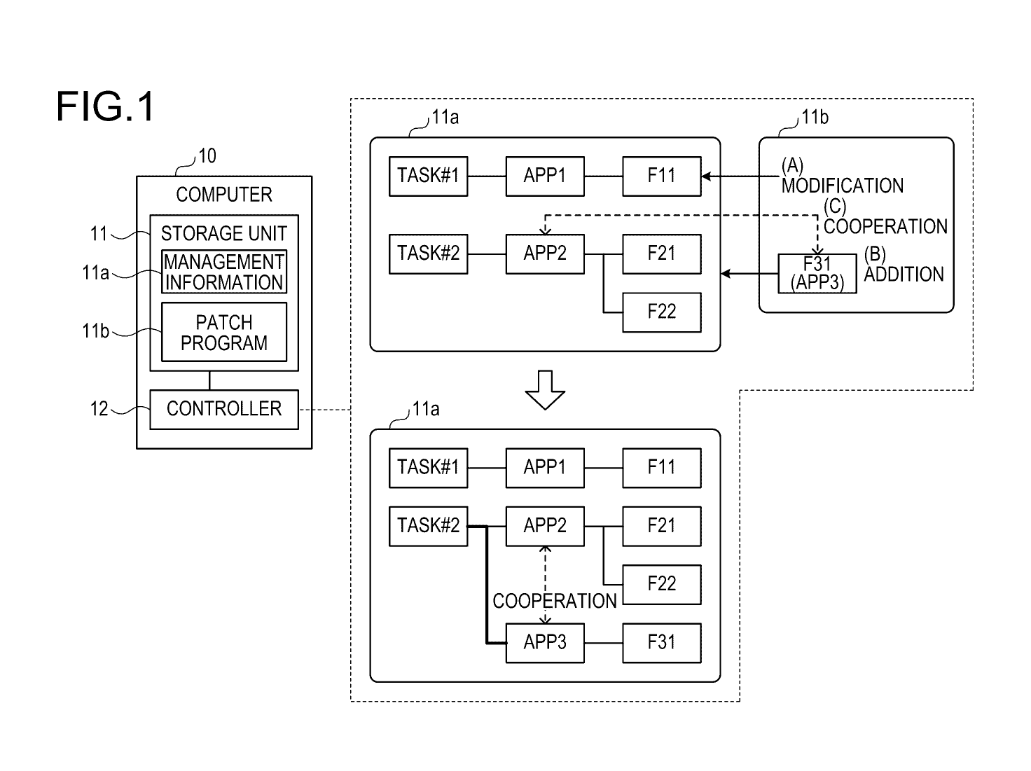

A first embodiment will be described with reference to FIG. 1. FIG. 1 is a diagram illustrating an example of a computer according to the first embodiment.

The first embodiment relates to a method for appropriately determining a task to be stopped when a patch program is applied to an application program executed by a computer. The patch program is applied to perform a modification such as adding a new feature or fixing a bug to the application program.

The application of a patch program is performed after stopping the application program to be modified by the application of the patch program and an application program that is using a file to be modified by the application of the patch program. The processing of a computer or an operation of a user, who uses the application program to be stopped, is stopped due to the application of the patch program. Therefore, the number of application programs to be stopped when the patch program is applied is desirably small.

The task performed by the user using a computer is carried out using one or more application programs or files. When a plurality of application programs are used in a task process performed by a computer during the task, the task may be interrupted when at least one of the application programs is to be stopped. Therefore, the number of task processes to be stopped when a patch program is applied is desirably small.

Further, in a case where there is another application program that is used in the same task process that uses the application program to be modified and both application programs are operated in cooperation, there is a risk that the task process may be abnormally terminated when the patch program is applied without stopping the other application program. For example, when a modification such as deletion or replacement is made to an application program which is in cooperation with another application program or file that is being used, the cooperation may be unable to be continued or a reference to the file may be unable to be performed.

In the first embodiment, a method is proposed in which a mechanism for managing information on application programs or files on the basis of task processing is provided to for efficiently apply a patch program to an application program while suppressing the above-described risk. This method may be implemented, for example, by a computer 10 illustrated in FIG. 1.

The computer 10 includes a storage unit 11 and a controller 12.

The storage unit 11 may be a volatile storage device such as a random access memory (RAM), or a non-volatile storage device such as a hard disk drive (HDD) or a flash memory. The controller 12 is a processor such as a central processing unit (CPU) or a digital signal processor (DSP). The controller 12 may be an electronic circuit such as an application specific integrated circuit (ASIC) or a programmable logic device (PLD). The controller 12 executes a program stored in the storage unit 11 or another memory.

The storage unit 11 stores therein management information 11a and a patch program 11b.

The management information 11a associates one or more task processes with information on an application program or file that is used in the respective one or more task processes. In the example of FIG. 1, a correspondence relationship between a task and an application program or file in the management information 11a is illustrated in a tree structure, for convenience of explanation, but the storage unit 11 may store therein the management information 11a that represents the correspondence relationship in different formats such as a table format.

FIG. 1 illustrates the management information 11a of task processes of tasks Task#1 and Task#2. Task#1 and Task#2 are arbitrary tasks such as accounting tasks, order-obtaining tasks, stock management tasks, and delivery tasks. The task processes are processes performed by the computer 10 when such tasks are performed.

In this example, an application program APP1 is associated with the task process of Task#1, and a file F11 is associated with the application program APP1. This information represents a relationship in which the application program APP1 is used in the task process of Task#1 and the application program APP1 uses the file F11.

Further, in this example, an application program APP2 is associated with the task process of Task#2, and files F21 and F22 are associated with the application program APP2. This information represents a relationship in which the application program APP2 is used in the task process of Task#2 and the application program APP2 uses the files F21 and F22.

The application of the patch program 11b causes a modification of the application program or file. The patch program 11b illustrated in FIG. 1 causes the computer 10 (A) to modify the file F11, and (B) add a file F31.

The file F31 is a file that is used by an application program APP3. The file F31 is also used in the application program APP2 after the patch program 11b is applied. That is, the patch program 11b causes the computer 10 (C) to make the application programs APP2 and APP3 to cooperate with each other via the file F31 which is newly added.

The processing of applying the patch program 11b is performed by the controller 12. When the patch program 11b is applied, the controller 12 updates information on the application program or file stored in association with the task process that uses the application program or file to be modified on the basis of the information on the application program or file included in the patch program 11b.

In the example of FIG. 1, when the patch program 11b is applied, the controller 12 (A) modifies the file F11, for example, by replacing the file F11 with a modified file. If a storage location of the file is changed or a file name is changed due to the modification, the controller 12 reflects the change in the management information 11a. Further, the controller 12 (B) stores the file F31 in a location (for example, storage unit 11) to which the application programs APP2 and APP3 may refer.

Then, the controller 12 adds the information on the application program APP3 and the file F31 to the management information 11a. At this time, the controller 12 identifies, by referring to information ((A) to (C) in the example of FIG. 1) indicating the contents of processing caused by the patch program 11b, the application program APP2 that uses the file F31 after the patch program 11b is applied. Then, the controller 12 identifies the task process of Task#2 in which the application program APP2 is used.

The controller 12 updates the management information 11a such that the application program APP3 using the file F31 is associated with the identified task process of Task#2. The controller 12 adds the correspondence relationship between the application program APP3 and the file F31 to the management information 11a. The controller 12 may add a cooperative relationship between the application programs APP2 and APP3 to the management information 11a as illustrated in FIG. 1.

As described above, according to the first embodiment, a change in the correspondence relationship between an application program or file and a task due to the application of the patch program 11b may be reflected in the management information 11a. Therefore, when a patch program is newly applied, a task involving an application program or file to be changed may easily be identified by referring to the management information 11a. As a result, a task required to be stopped when the patch program is applied may be identified appropriately on the basis of the management information 11a, and the application of the patch program may be completed without stopping a task not required to be stopped.

### Second Embodiment

Next, a second embodiment will be described. The second embodiment relates to a method capable of appropriately determining a task to be stopped when a patch program for performing a modification such as adding a new feature or fixing a bug is applied to an application program executed by a computer.

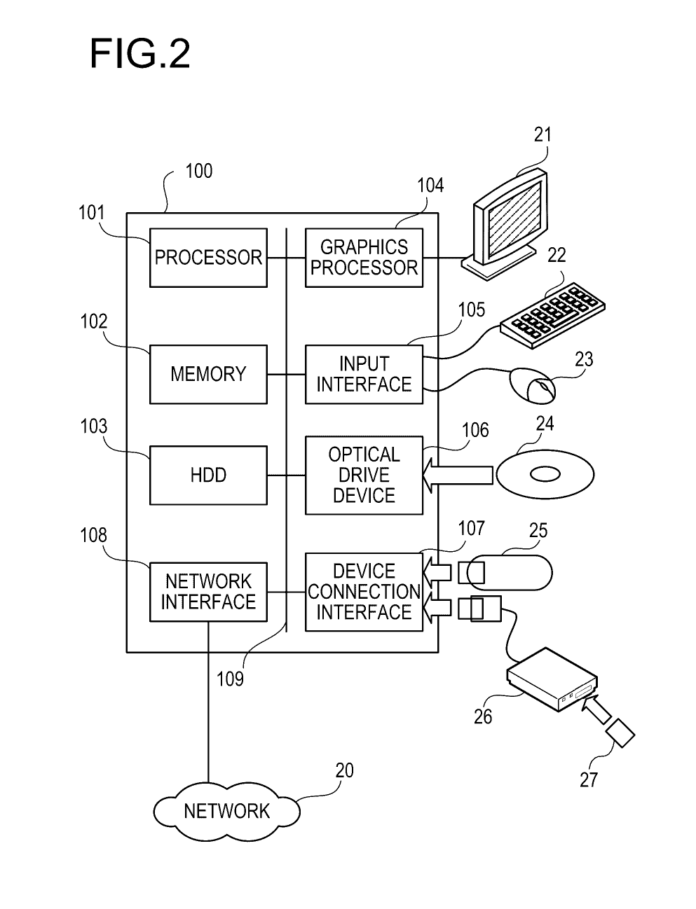

The method according to the second embodiment may be implemented, for example, by an information processing apparatus 100 having a hardware configuration illustrated in FIG. 2. FIG. 2 is a diagram illustrating an exemplary hardware configuration of the information processing apparatus according to the second embodiment.

The information processing apparatus 100 is entirely controlled by a processor 101. A memory 102 and a plurality of peripheral devices are connected to the processor 101 via a bus 109. The processor 101 may be a multi-processor. The processor 101 is, for example, a CPU, a micro processing unit (MPU), or a DSP. At least a part of the functions, which the processor 101 implements by executing a program, may be implemented by an electronic circuit such as an ASIC and a PLD.

The memory 102 is used as a main storage device of the information processing apparatus 100. At least a part of an application program or program of an operating system (OS) to be executed by the processor 101 is temporarily stored in the memory 102. Further, various data used by the processor 101 for processing is stored in the memory 102. As for the memory 102, for example, a volatile semiconductor memory device such as RAM is used.

Peripheral devices such as an HDD 103, a graphics processor 104, an input interface 105, an optical drive device 106, a device connection interface 107, and a network interface 108 are connected to the bus 109.

The HDD 103 magnetically performs writing and reading of data with respect to a built-in disk. The HDD 103 is used as an auxiliary storage device of the information processing apparatus 100. In the HDD 103, OS programs, application programs, and various data are stored. A non-volatile semiconductor memory device (for example, a solid state drive (SSD)) such as a flash memory may also be used for the auxiliary storage device.

A monitor 21 is connected to the graphics processor 104. The graphics processor 104 displays an image on the screen of the monitor 21 in accordance with instructions from the processor 101. A liquid crystal display device and a display device using a cathode ray tube (CRT) may be used for the monitor 21.

A keyboard 22 and a mouse 23 are connected to the input interface 105. The input interface 105 transmits a signal sent from the keyboard 22 or the mouse 23 to the processor 101. The mouse 23 is an example of a pointing device, and other pointing devices, such as a touch panel, a tablet, a touch pad, a track ball, and the like, may be used.

The optical drive device 106 reads data recorded on an optical disk 24 by using, for example a laser beam. The optical disk 24 is a portable recording medium on which data is recorded so as to be read by the reflection of light. Various types of devices are used for the optical disk 24 including a digital versatile disc (DVD), DVD-RAM, a compact disc read-only memory (CD-ROM), CD-R(Recordable)/RW(ReWritable), and the like.

The device connection interface 107 is a communication interface for connecting peripheral devices to the information processing apparatus 100. For example, a memory device 25 or a memory reader/writer 26 may be connected to the device connection interface 107. The memory device 25 is a recording medium having a function of communicating with the device connection interface 107. The memory reader/writer 26 is a device that writes data to a memory card 27 or reads data from the memory card 27. The memory card 27 is a card-type recording medium.

The network interface 108 is connected to an internal network 20. The network interface 108 transmits/receives data to/from another computer or communication device via the internal network 20.

The information processing apparatus 100 may be implemented with the hardware configuration described above. The functions of the computer 10 according to the first embodiment may also be implemented by a similar hardware configuration as illustrated in FIG. 2.

The information processing apparatus 100 implements the processing functions according to the second embodiment, for example, by executing a program recorded on a computer-readable recording medium. The program describing the processing contents to be executed by the information processing apparatus 100 may be recorded on various types of recording media. For example, a program to be executed by the information processing apparatus 100 may be stored in the HDD 103.

The processor 101 loads at least a part of the program stored in the HDD 103 into the memory 102, and executes the program. A program to be executed by the information processing apparatus 100 may be recorded in a portable recording medium such as the optical disk 24, the memory device 25, and the memory card 27. The program stored in the portable recording medium may become executable after being installed in the HDD 103, for example, under the control of the processor 101. The processor 101 may read and execute the program directly from the portable recording medium.

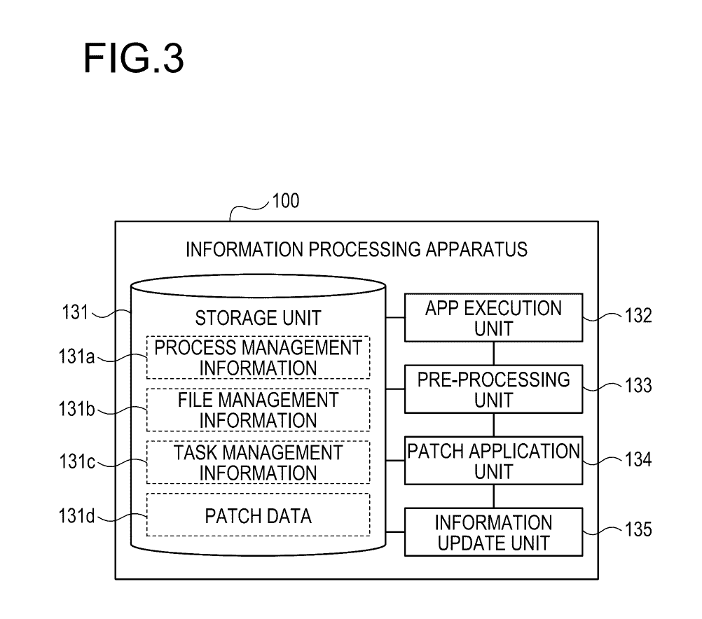

Next, the functions of the information processing apparatus 100 will be described with reference to FIG. 3. FIG. 3 is a diagram illustrating an example of functions of the information processing apparatus according to the second embodiment.

As illustrated in FIG. 3, the information processing apparatus 100 includes a storage unit 131, an APP execution unit 132, a pre-processing unit 133, a patch application unit 134, and an information update unit 135.

The functions of the storage unit 131 may be implemented by using the memory 102 or the HDD 103 described above. The functions of the APP execution unit 132, the pre-processing unit 133, the patch application unit 134, and the information update unit 135 may be implemented by using the processor 101 described above.

The storage unit 131 stores therein process management information 131a, file management information 131b, task management information 131c, and patch data 131d. The storage unit 131 also stores therein an application program to be executed by the APP execution unit 132, which will be described later, or a file used during the execution of the application program.

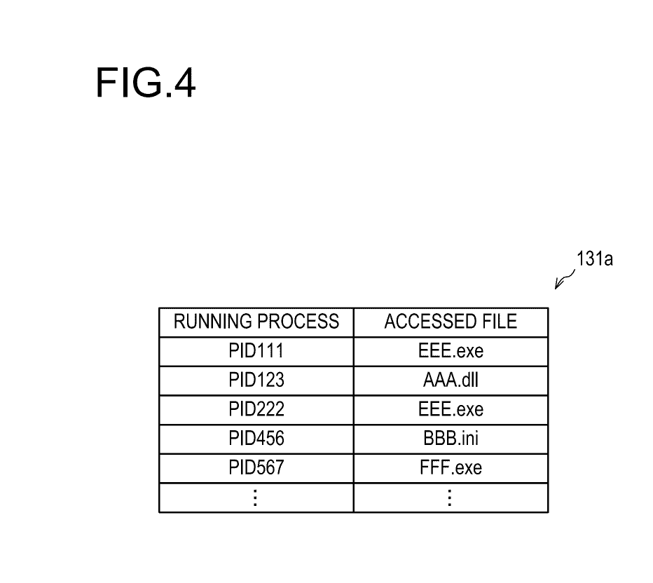

An example of the process management information 131a is illustrated in FIG. 4. FIG. 4 is a diagram illustrating an example of the process management information according to the second embodiment. The process management information 131a is information for associating a process which is started by the execution of instructions described in the application program with a file (accessed file) to be used in the process. The storage unit 131 stores therein the process management information 131a for associating a process identifier (PID) for identifying a process (running process) being operated in the information processing apparatus 100 with an accessed file corresponding to each running process.

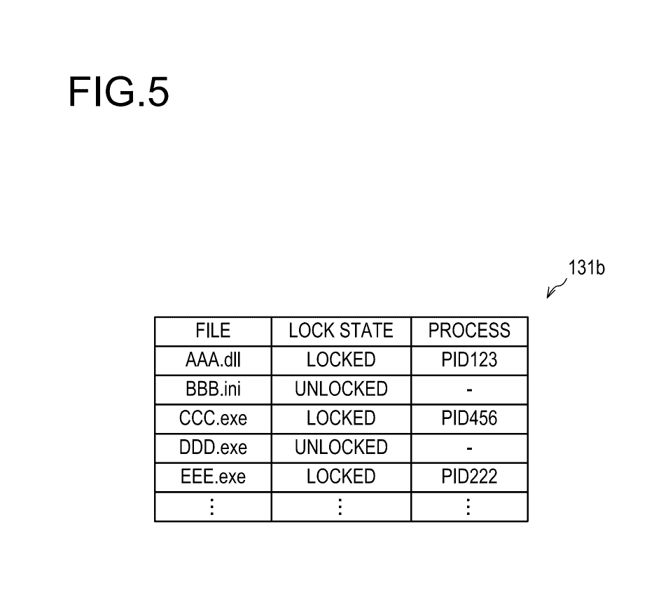

An example of the file management information 131b is illustrated in FIG. 5. FIG. 5 is a diagram illustrating an example of the file management information according to the second embodiment. The file management information 131b is information for associating a file available in the information processing apparatus 100 with a lock state (locked/unlocked) of each file and a running process that has locked the file. When a file is in a locked state, modification of the file due to the application of a patch program should not be performed unless the running process that has locked the file is stopped.

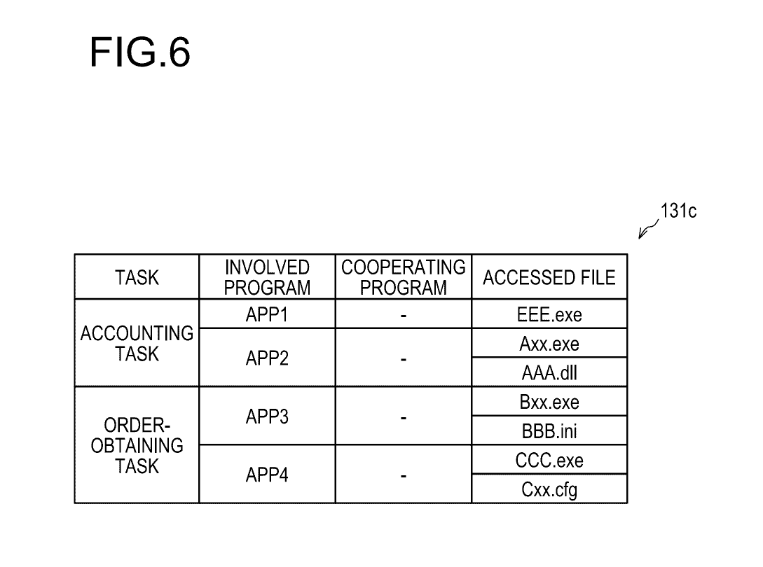

An example of the task management information 131c is illustrated in FIG. 6. FIG. 6 is a diagram illustrating an example of the task management information according to the second embodiment. The task management information 131c is information for associating a task with an application program (involved program) to be used in the task, an application program (cooperating program) to cooperate with the involved program, and a file to be used by the involved program. In the task management information 131c illustrated in FIG. 6, information on an application program to be a cooperation counterpart is recorded in a field for the cooperating program.

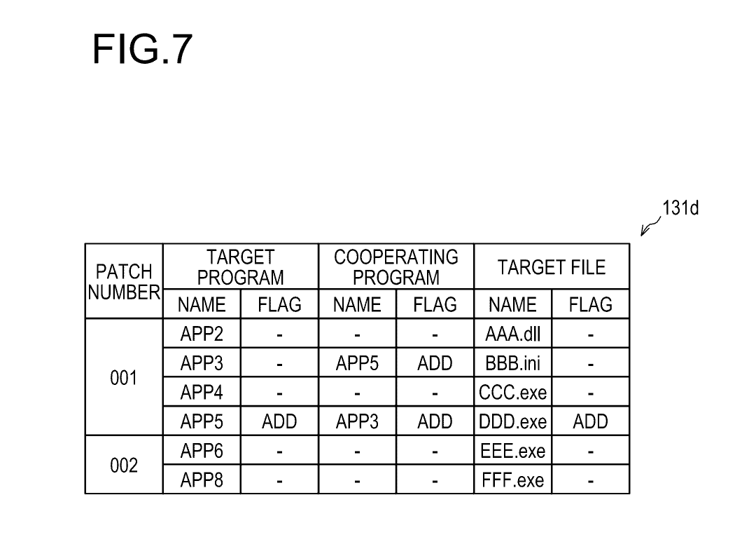

An example of the patch data 131d is illustrated in FIG. 7. FIG. 7 is a diagram illustrating an example of the patch data according to the second embodiment. The patch data 131d is data indicating the contents of processing performed when the patch program is applied to an application program.

The patch data 131d includes information on target programs, cooperating programs, and target files for each patch number that identifies a set of processing to be applied. The information on a target program includes a name of a target program and a flag that indicates a specific change. The information on a cooperating program includes a name of a cooperating program and a flag that indicates a specific change. The information on a target file includes a name of a target file and a flag that indicates a specific change.

The specific change includes, for example, an addition, a name change, a deletion, or a path change. The addition indicates an addition of an application program or file. The name change indicates a change of a name of an application program or file. The deletion indicates a deletion of an application program or file. The path change indicates a change of a path indicating a storage location of a file. When a flag of the name change is set, a new name after the name change may be recorded in the patch data 131d.

Referring back to FIG. 3, the APP execution unit 132 executes an application program stored in the storage unit 131. The APP execution unit 132 uses a file stored in the storage unit 131 when executing an application program. The pre-processing unit 133 performs processing such as stopping, before applying a patch program, a process that has locked a file to be changed due to the application of the patch program. At this time, the pre-processing unit 133 determines the process to be stopped on the basis of the task management information 131c.

The patch application unit 134 applies a patch program on the basis of the patch data 131d. In a case where time information on a time period of stopping a task is stored in the storage unit 131, the patch application unit 134 applies the patch program during the time period of stopping the task by referring to the time information. The time information includes, for example, a start time and an end time for each task. The information update unit 135 updates the task management information 131c after the patch program is applied. At this time, the information update unit 135 reflects the information on the changed application program or file in the task management information 131c by referring to the patch data 131d.

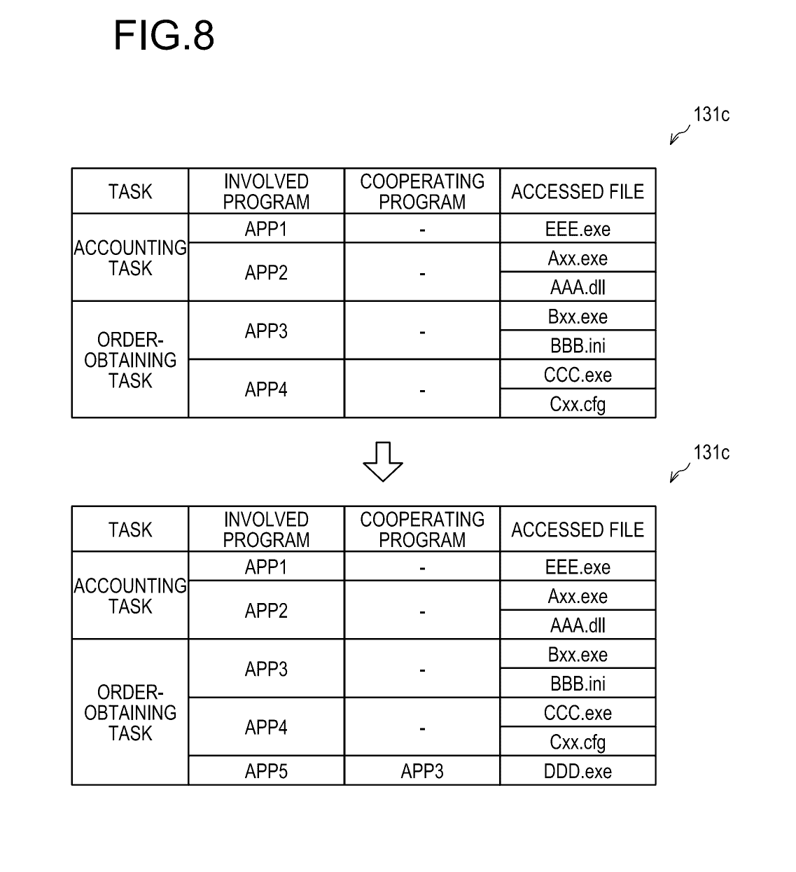

Here, a method of updating the task management information 131c will be described with reference to FIGS. 8 to 10. FIGS. 8 to 10 are diagrams illustrating a method of updating the task management information to be performed, when a patch program is applied, according to the second embodiment.

FIG. 8 illustrates the contents of the task management information 131c to be changed by the information update unit 135 when a patch program having a patch number of “001” (see FIG. 7) is applied. When the patch program (patch program 001) is applied, an application program APP5 that cooperates with an application program APP3 is added. Further, a file having a name of DDD.exe, which is accessed by the application program APP5, is added.

In this case, in the task management information 131c, as illustrated in FIG. 8, APP5 is added to a field of the involved program, APP3 is added to a corresponding field of the cooperating program, and DDD.exe is added to a corresponding field of the accessed file. The information update unit 135 identifies a task (“order-obtaining task” in this example) in which the application program APP3 that cooperates with the application program APP5 is used by referring to the task management information 131c, and associates the application program APP5 with the identified task.

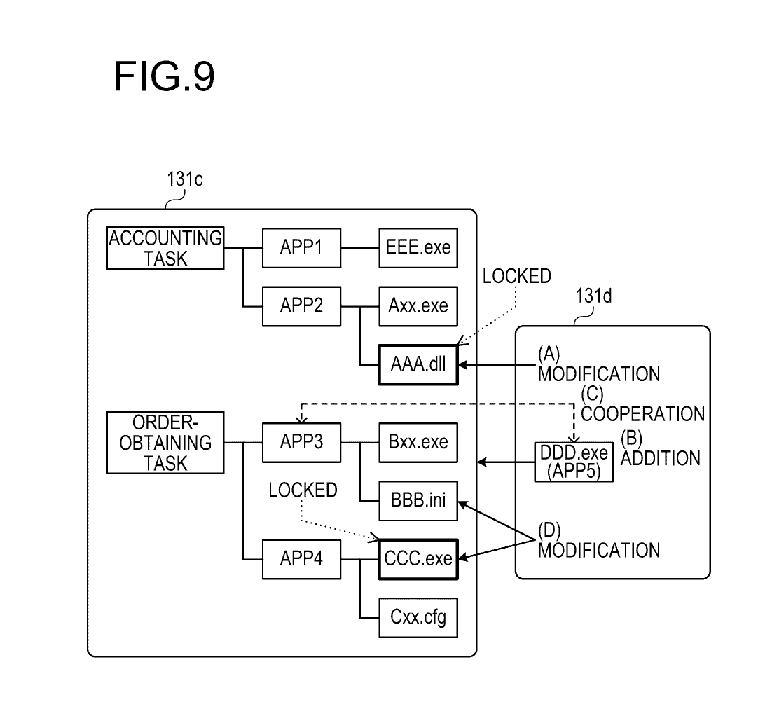

The relationship among the task, the application program, and the file according to the task management information 131c may be expressed in the form of a tree as illustrated in FIG. 9. The processing of the patch program 001 according to the patch data 131d includes (A) a modification to a file AAA.dll, (B) an addition of a file DDD.exe to be used by the application program APP5, and (D) a modification of a file CCC.exe. (C) The application programs APP3 and APP5 cooperate with each other through the file DDD.exe.

In the example of FIG. 9, the files AAA.dll and CCC.exe are in a locked state. A file in the locked state may be identified on the basis of the file management information 131b. Further, a process that has locked the file may be identified on the basis of the process management information 131a. The pre-processing unit 133 identifies a task corresponding to the file to be modified on the basis of the task management information 131c, and stops a process of an application program corresponding to the identified task.

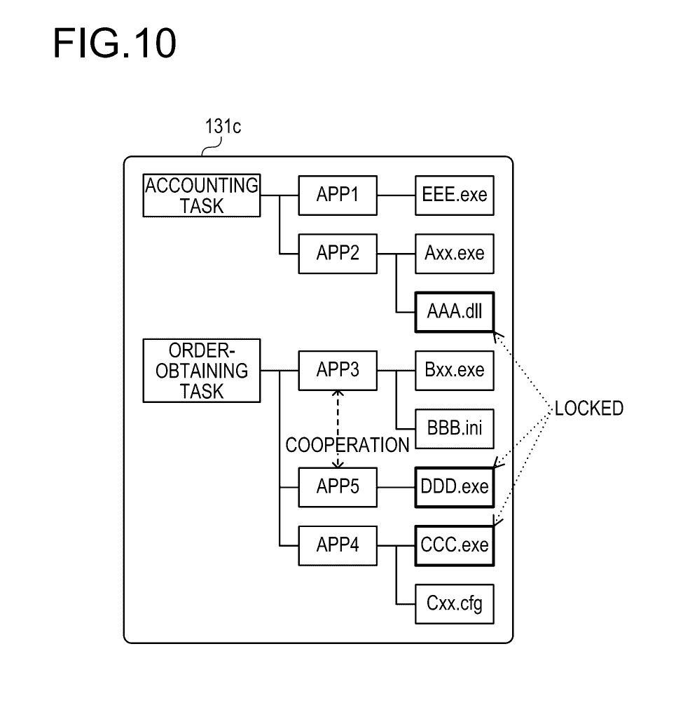

On the basis of the patch data 131d, the patch application unit 134 (A) modifies the file AAA.dll, (B) adds the file DDD.exe, and (D) modifies the file CCC.exe. The information update unit 135 reflects a change due to the application of the patch program in the task management information 131c. At this time, the information update unit 135 (C) associates the application program APP5 with the order-obtaining task, with which the application program APP3 is associated, in consideration of the cooperation of the application programs APP3 and APP5 (see FIG. 10).

As described above, when an application program or file is added in the application of a patch program, the information update unit 135 updates the task management information 131c in consideration of the relationship of cooperation between application programs in performing a task. By using the task management information 131c, the process to be stopped when a patch program is newly applied may be identified by the pre-processing unit 133 on a task basis. As a result, a risk of abnormally stopping a task when the patch program is applied may be suppressed, and the number of tasks to be stopped may be reduced because a task that is not required to be stopped is not stopped.

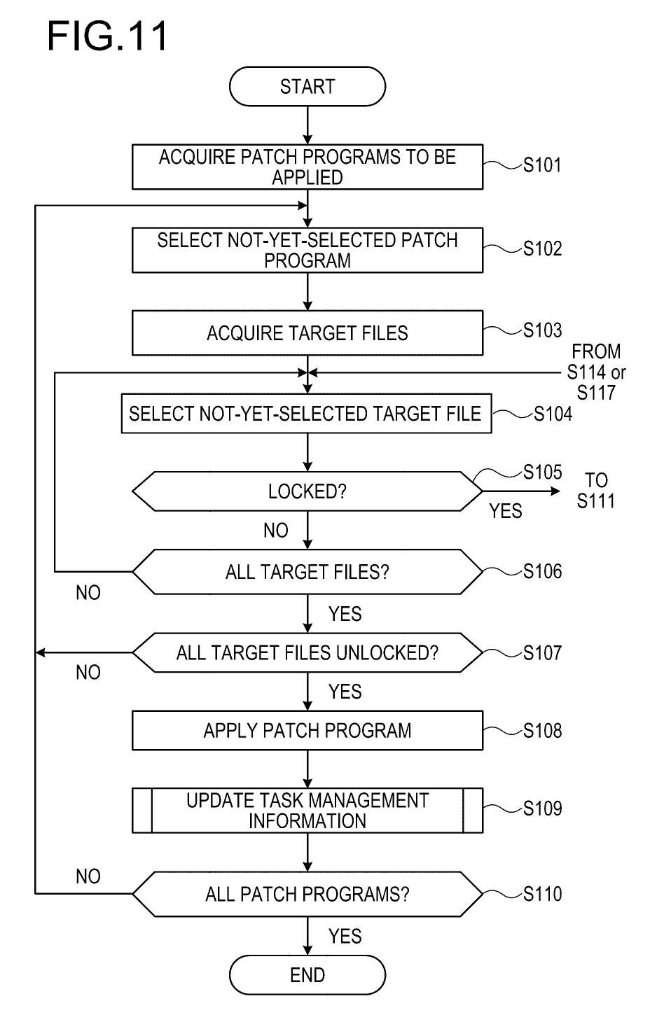

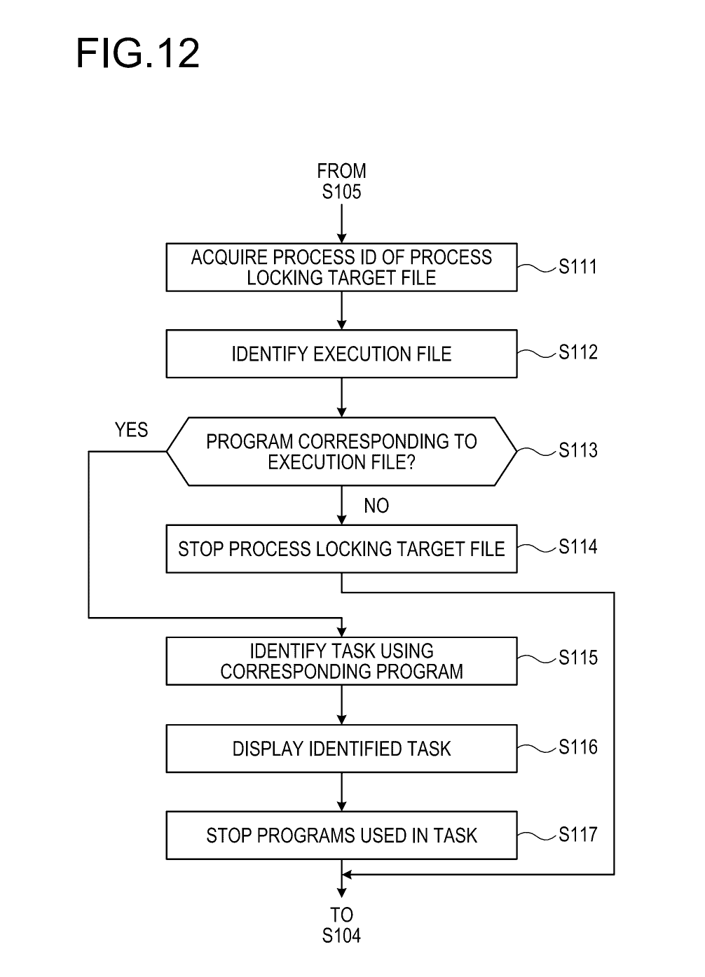

Next, a flow of processing performed by the information processing apparatus 100 when a patch program is applied will be described with reference to FIGS. 11 and 12. FIGS. 11 and 12 are a flowchart illustrating a flow of processing performed by the information processing apparatus according to the second embodiment.
(S101) The pre-processing unit 133 acquires patch programs to be applied. When a patch program is stored in the storage unit 131, the pre-processing unit 133 reads out the patch program to be applied from the storage unit 131. At this time, the pre-processing unit 133 acquires the patch data 131d indicating the contents of the change of an application program or file due to the application of the patch program. The patch data 131d is, for example, included in the patch program.

When a patch program is provided from another device (such as a server or a storage device) connected directly or indirectly via a network to the information processing apparatus 100, the pre-processing unit 133 may acquire the patch program from the other device.

The timing of applying a patch program may be set to a time period during which the task is stopped, such as at night. Time information indicating a start time and an end time of the task may be stored in advance in the storage unit 131, and the pre-processing unit 133 may identify a time period of stopping the task by referring to the time information, and determine whether the application of the patch program is started on the basis of the identified time period of stopping the task. In this case, the pre-processing unit 133 starts the application of the patch program when it is determined, on the basis of the stop time period for each task, that the task to be stopped due to the application of the patch program is stopped.
(S102) The pre-processing unit 133 selects one not-yet-selected patch program among the patch programs acquired in S101.
(S103) The pre-processing unit 133 acquires target files. A target file is a file to be changed due to the application of the selected patch program.

For example, when the change is replacing a file, the pre-processing unit 133 acquires a new file with which an old file is to be replaced. When the change is adding a file, the pre-processing unit 133 acquires a new file to be added. The pre-processing unit 133 acquires the new file from the storage unit 131 when the new file is stored in the storage unit 131, and acquires the new file from another device when the new file is provided from the other device.
(S104) The pre-processing unit 133 selects one not-yet-selected target file among the target files acquired in S103.
(S105) The pre-processing unit 133 determines, by referring to the file management information 131b, whether the target file selected in S104 is in a locked state. When it is determined that the target file is in a locked state, the processing proceeds to S111 of FIG. 12. When it is determined that the target file is not in a locked state, the processing proceeds to S106.
(S106) The pre-processing unit 133 determines whether all of the target files acquired in S103 have been selected. When it is determined that all of the target files have been selected, the processing proceeds to S107. When it is determined that there are some not-yet-selected target files, the processing proceeds to S104.
(S107) The pre-processing unit 133 determines whether all of the target files acquired in S103 are in an unlocked state. When it is determined that all of the target files are in an unlocked state, the processing proceeds to S108. When it is determined that there are some target files in a locked state, the processing proceeds to S102. Since a target file in a locked state is unable be changed, a patch program causing a change to the target file is not applied.
(S108) The patch application unit 134 applies the patch program selected in S102. For example, when the patch program 001 (see FIG. 7) is applied, the patch application unit 134 changes the target files AAA.dll, BBB.ini, and CCC.exe used by the target programs APP2, APP3, and APP4. Further, the patch application unit 134 adds the target file DDD.exe used by the target program APP5 and makes the target programs APP3 and APP5 to cooperate with each other.
(S109) The information update unit 135 updates the task management information 131c to reflect, in the task management information 131c, the relationship between the task and the application program or file after the patch program is applied (see FIGS. 9 and 10). The processing of S109 will be further described later.
(S110) The pre-processing unit 133 determines whether all of the patch programs acquired in S103 have been selected. When it is determined that all of the patch programs have been selected, the series of processing illustrated in FIGS. 11 and 12 are terminated. When it is determined that there are some not-yet-selected patch programs, the processing proceeds to S102.
(S111) The pre-processing unit 133 acquires a process identifier (ID) of a process that has locked the target file by referring to the file management information 131b.
(S112) The pre-processing unit 133 identifies an execution file on the basis of the process ID acquired in S111 by referring to the file management information 131b.
(S113) The pre-processing unit 133 determines whether a program (involved program or cooperating program) corresponding to the execution file identified in S112 is in the task management information 131c. When it is determined that a corresponding program is in the task management information 131c, the processing proceeds to S115. When it is determined that no corresponding program is in the task management information 131c, the processing proceeds to S114.
(S114) The pre-processing unit 133 stops the process that has locked the target file. By stopping the process, the lock of the target file is released. When the processing of S114 is completed, the processing proceeds to S104 of FIG. 11.
(S115) The pre-processing unit 133 identifies, by referring to the task management information 131c, a task that uses the program corresponding to the execution file identified in S112. The task identified in S115 corresponds to the task to be stopped when the patch program is applied.
(S116) The pre-processing unit 133 displays the task identified in S115, as a task to be stopped, on the monitor 21.
(S117) The pre-processing unit 133 stops, by referring to the task management information 131c, the programs (involved program or cooperating program) to be used in the task identified in S115. By the stopping of the programs, all processes that have been performed by the programs are stopped, and the lock of the target files by these processes is released. When the processing of S117 is completed, the processing proceeds to S104 of FIG. 11.

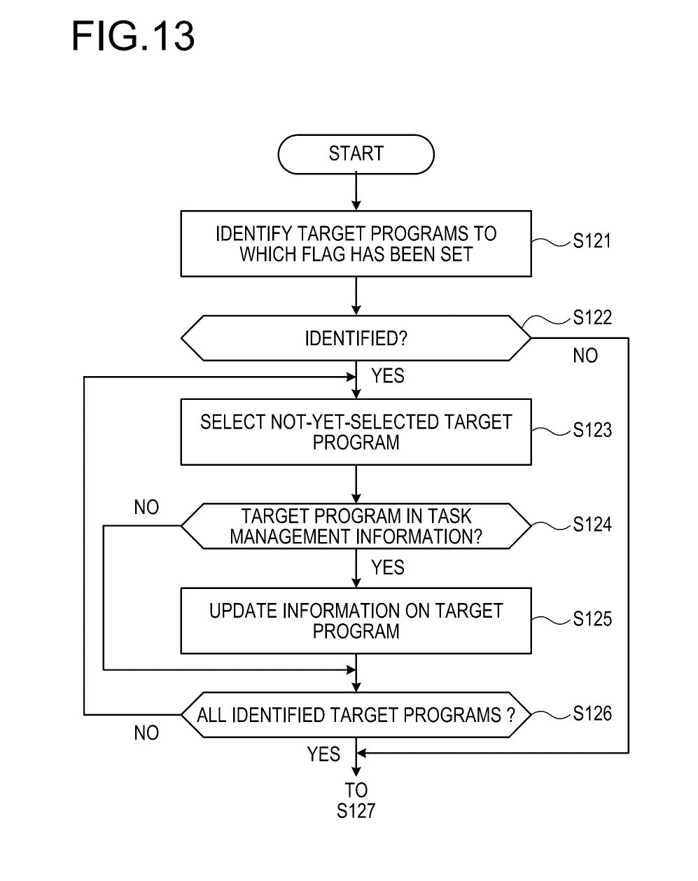

Hereinafter, the processing of updating the task management information 131c (see S109) will be described with reference to FIGS. 13 to 15.

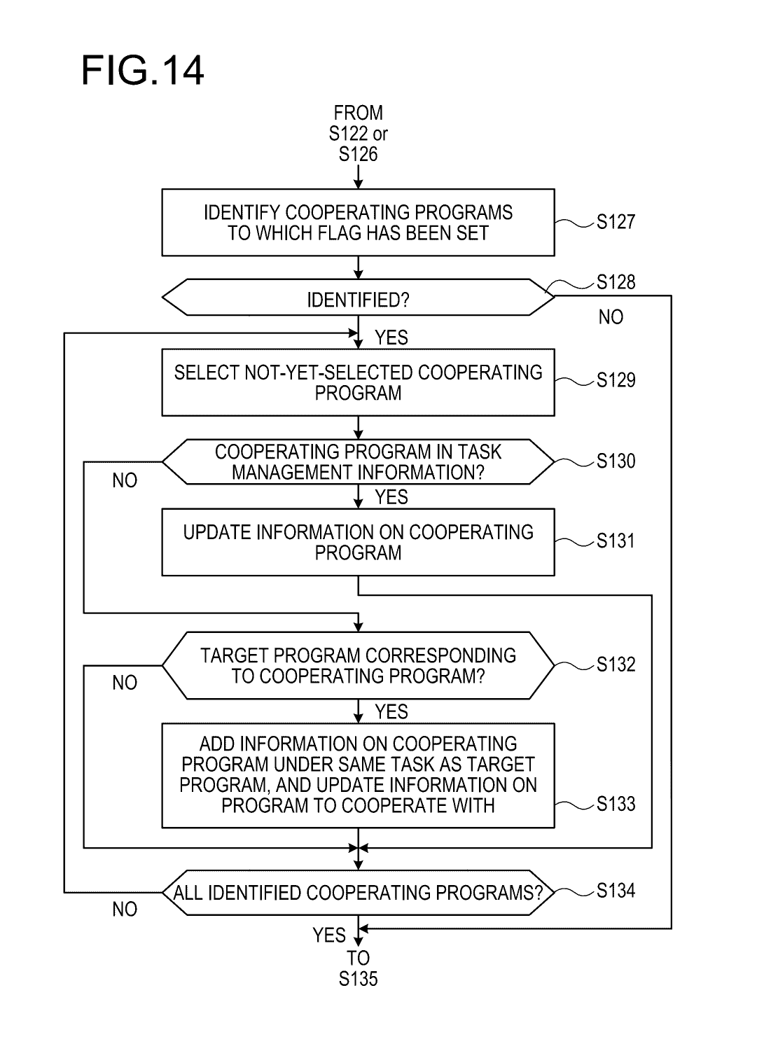

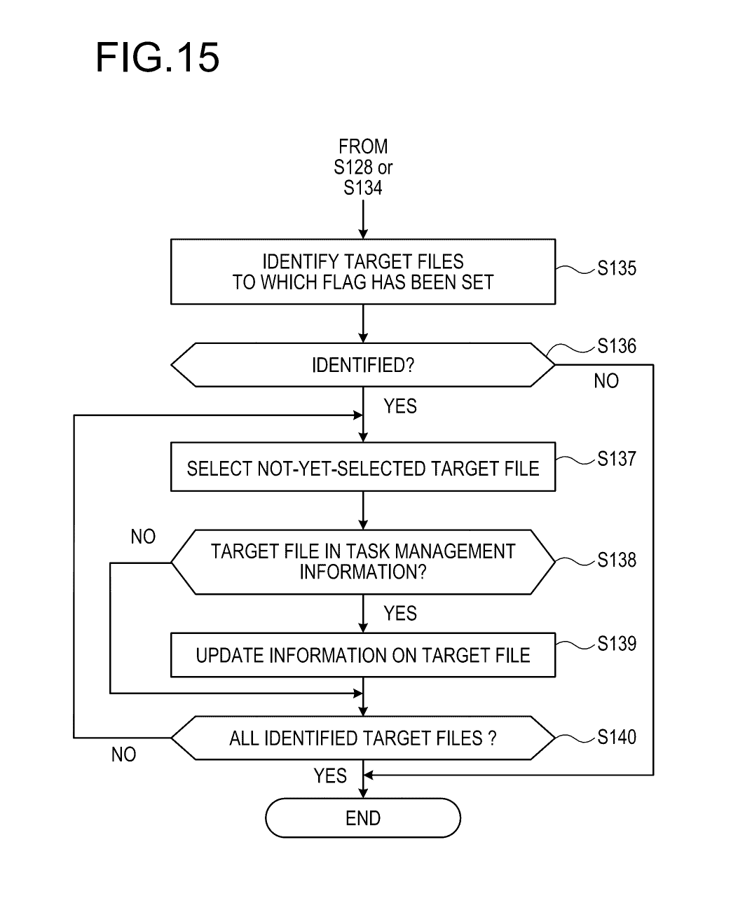

FIGS. 13 to 15 are a flowchart illustrating a flow of processing for updating the task management information performed by the information processing apparatus according to the second embodiment.
(S121) The pre-processing unit 133 identifies, on the basis of the patch data 131d of the patch program to be applied, a target program to which a flag has been set. For example, when the patch program 001 is applied (see FIG. 7), a flag “Add” has been set to the target program APP5. In this case, the pre-processing unit 133 identifies the target program APP5 as the target program to which a flag has been set.
(S122) The pre-processing unit 133 determines whether there are target programs, to which a flag has been set, in the patch data 131d of the patch program to be applied. When it is determined that there are target programs to which a flag has been set, the processing proceeds to S123. When it is determined that there is no target program to which a flag has been set, the processing proceeds to S127 of FIG. 14.
(S123) The pre-processing unit 133 selects one not-yet-selected target program among the target programs identified in S121.
(S124) The pre-processing unit 133 determines whether the target program selected in S123 is in the task management information 131c. When it is determined that the target program is in the task management information 131c, the processing proceeds to S125. However, when the flag set to the target program is “Add”, the processing proceeds to S126. When it is determined that the target program is not in the task management information 131c, the processing proceeds to S126.
(S125) The information update unit 135 updates the information on the target program in the task management information 131c. When the flag of the target program is “Add”, the processing does not proceed to S125. Accordingly, the update of the task management information 131c corresponding to “Change Name” or “Delete” set to the flag is performed in S125. For example, in the case of “Change Name”, the name of the involved program is changed. In the case of “Delete”, the information on the involved program is deleted.
(S126) The pre-processing unit 133 determines whether all of the target programs identified in S121 have been selected. When it is determined that all of the target programs have been selected, the processing proceeds to S127 of FIG. 14. When it is determined that there are some not-yet-selected target programs, the processing proceeds to S123.
(S127) The pre-processing unit 133 identifies, on the basis of the patch data 131d of the patch program to be applied, a cooperating program to which a flag has been set. For example, when the patch program 001 is applied (see FIG. 7), a flag “Add” has been set to the cooperating programs APP3 and APPS. In this case, the pre-processing unit 133 identifies the cooperating programs APP3 and APP5 as the cooperating programs to which a flag has been set.
(S128) The pre-processing unit 133 determines whether there are cooperating programs, to which a flag has been set, in the patch data 131d of the patch program to be applied. When it is determined that there are cooperating programs to which a flag has been set, the processing proceeds to S129. When it is determined that there is no cooperating program to which a flag has been set, the processing proceeds to S135 of FIG. 15.
(S129) The pre-processing unit 133 selects one not-yet-selected cooperating program from the cooperating programs identified in S127.
(S130) The pre-processing unit 133 determines whether the cooperating program selected in S129 is in the task management information 131c. When it is determined that the cooperating program is in the task management information 131c, the processing proceeds to S131. When it is determined that the cooperating program is not in the task management information 131c, the processing proceeds to S132.
(S131) The information update unit 135 updates the information on the cooperating program in the task management information 131c. The update of the task management information 131c corresponding to one of “Add”, “Change Name”, and “Delete” set to the flag is performed in S131. For example, in the case of “Add”, the information on the cooperating program is added. In the case of “Change Name”, the name of the cooperating program is changed. In the case of “Delete”, the information on the cooperating program is deleted. When the processing of S131 is completed, the processing proceeds to S134.
(S132) The pre-processing unit 133 determines whether a target program corresponding to the cooperating program selected in S129 is in the task management information 131c. When it is determined that the target program is in the task management information 131c, the processing proceeds to S133. When it is determined that the target program is not in the task management information 131c, the processing proceeds to S134.
(S133) The information update unit 135, for the task management information 131c, adds the information on the cooperating program in association with the same task as the target program corresponding to the cooperating program selected in S129, and updates the information on the cooperating program to cooperate with (see FIG. 8).
(S134) The pre-processing unit 133 determines whether all of the cooperating programs identified in S127 have been selected. When it is determined that all of the cooperating programs have been selected, the processing proceeds to S135 of FIG. 15. When it is determined that there are any not-yet-selected cooperating programs, the processing proceeds to S129.
(S135) The pre-processing unit 133 identifies, on the basis of the patch data 131d of the patch program to be applied, target files to which a flag has been set. For example, when applying the patch program 001 (see FIG. 7), a flag “Add” has been set to the target file DDD.exe. In this case, the pre-processing unit 133 identifies the target file DDD.exe as the target file to which a flag has been set.
(S136) The pre-processing unit 133 determines whether there are target files, to which a flag has been set, in the patch data 131d of the patch program to be applied. When it is determined that there are target files to which a flag has been set, the processing proceeds to S137. When it is determined that there is no target file to which a flag has been set, the series of processing illustrated in FIGS. 13 to 15 are terminated.
(S137) The pre-processing unit 133 selects one not-yet-selected target file among the target files identified in S135.
(S138) The pre-processing unit 133 determines whether the target file selected in S137 is in the task management information 131c. When it is determined that the target file is in the task management information 131c, the processing proceeds to S139. When it is determined that the target file is not in the task management information 131c, the processing proceeds to S140.
(S139) The information update unit 135 updates the information on the target file in the task management information 131c. For example, in the case of “Add”, the information on the target file is added. In the case of “Change Name”, the name of the target file is changed. In the case of “Delete”, the information on the target file is deleted.
(S140) The pre-processing unit 133 determines whether all of the target files identified in S135 have been selected. When it is determined that all of the target files have been selected, the series of processing illustrated in FIGS. 13 to 15 are terminated. When it is determined that there are any not-yet-selected target files, the processing proceeds to S137.

As described above, according to the second embodiment, a change in the correspondence relationship between an application program or file and a task due to the application of a patch program may be reflected in the task management information 131c. Therefore, when a patch program is newly applied, a task involving an application program or file to be changed may easily be identified by referring to the task management information 131c. As a result, a task required to be stopped when the patch program is applied may be identified appropriately on the basis of the task management information 131c, and the application of the patch program may be completed without stopping a task not required to be stopped.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
storing task identifiers of respective tasks in a storage unit in association with information on an application program or file to be used in the respective tasks; and
updating first information on a first application program or file on basis of second information on the first application program or file when a first patch program is applied, the first patch program causing a change on the first application program or file when the first patch program is applied, the first information being stored in the storage unit in association with a first task identifier of a first task, the second information being included in the first patch program.

2. The non-transitory computer-readable recording medium according to claim 1, the process further comprising:
determining that the first patch program is applicable during the first task is stopped.

3. The non-transitory computer-readable recording medium according to claim 1, the process further comprising:
displaying the first identifier on a display unit when the first patch program is applied.

4. The non-transitory computer-readable recording medium according to claim 1, the process further comprising:
storing third information on a second application program in the storage unit in association with a second task identifier when the second application program is added by applying a second patch program, the second application program cooperating with a third application program, the second task identifier being stored in the storage unit in association with fourth information on the third application program.

5. An update control method, comprising:
storing, by a computer, task identifiers of respective tasks in a storage unit in association with information on an application program or file to be used in the respective tasks; and
updating first information on a first application program or file on basis of second information on the first application program or file when a first patch program is applied, the first patch program causing a change on the first application program or file when the first patch program is applied, the first information being stored in the storage unit in association with a first task identifier of a first task, the second information being included in the first patch program.

6. An update control device, comprising:
a storage device; and
a processor configured to
store task identifiers of respective tasks in the storage device in association with information on an application program or file to be used in the respective tasks, and
update first information on a first application program or file on basis of second information on the first application program or file when a first patch program is applied, the first patch program causing a change on the first application program or file when the first patch program is applied, the first information being stored in the storage device in association with a first task identifier of a first task, the second information being included in the first patch program.
